(19) United States
(12) Patent Application Publication
(10) Pub. No.: US 2008/0111815 A1
(43) Pub. Date: May 15, 2008

(54) Modeling System

(75) Inventors: Robert Graves, London (GB); Didier Madoc Jones, London (GB)

Correspondence Address: BROOKS KUSHMAN P.C., 1000 TOWN CENTER, TWENTY-SECOND FLOOR, SOUTHFIELD, MI, 48075, US

(73) Assignee: GMJ CITYMODELS LTD, London (GB)

(21) Appl. No.: 10/596,291

(22) PCT Filed: Dec. 6, 2004
(86) PCT No.: PCT/GB04/05105

§ 371 Date: Oct. 2, 2007

(30) Foreign Application Priority Data
Dec. 8, 2003 (GB) 0328420.5

(51) Int. Cl. G06T 17/50

(52) U.S. Cl. 345/420

(57) ABSTRACT

A three dimensional model of an urban area is produced by processing a stereo aerial view of the urban area to obtain a three dimensional map, identifying city units by correlation with a geographical database and obtaining ground level image data relating to city units from photographic or laser scan image data. Data from the various sources is correlated to provide a high resolution geographically accurate three dimensional model of the urban area. The viewpoints from which ground level data is obtained are shown on the model and are linked to the underlying image data such that the model further provides an integrated database. As a result an accurate, rapidly processed and easily updateable three dimensional model is provided.

The invention relates to a modelling system in particular for providing a three dimensional model of a built up area.

Models of this type are useful for a range of applications including urban planning and development.

One well known modelling system is provided under the name “City Grid” available from Geodata GMBH, Leoben, Austria. According to this system a three dimensional urban model is built from aerial photography and street survey data combined with a large scale two dimensional geographical map data such as a GIS database. In particular a “massing model” approach is adopted whereby the height of each building on the two dimensional map provides a third coordinate to give a three dimensional model extrapolated from the two dimensional map. A library of building types can be used to replace the derived buildings and hence provide a more detailed model.

A further approach is described in Früh & Zakhor, University of California, Berkeley, “Constructing 3D City Models by Merging Aerial and Ground Views” IEEE Computer Graphics and Applications November/December 2003 pages 52 to 61, according to which an aerial laser scan of an urban area is combined with mobile acquisition of facade data together with mathematical image processing techniques. However the system adopted is imprecise in view of the goal of obtaining a photo-realistic virtual exploration of the city and is restricted to buildings. Further more additional information, such as the material from which an element is constructed, and which can alter its visual properties, is not extracted at the time of modelling. Furthermore, the automated approach described does not permit addition of geometric detail.

Various problems arise with existing systems. There are difficulties of the with extraction data from the three dimensional model. The accuracy of the model derived depends on the accuracy of the underlying geographical data. The accuracy of the model is also limited by the scope of the library of building elements relied upon. Production of known system is generally extremely labour intensive and update of the models can be very difficult.

The invention is set out in the claims.

Embodiments of the invention will now be described by way of example with reference to the drawings of which:

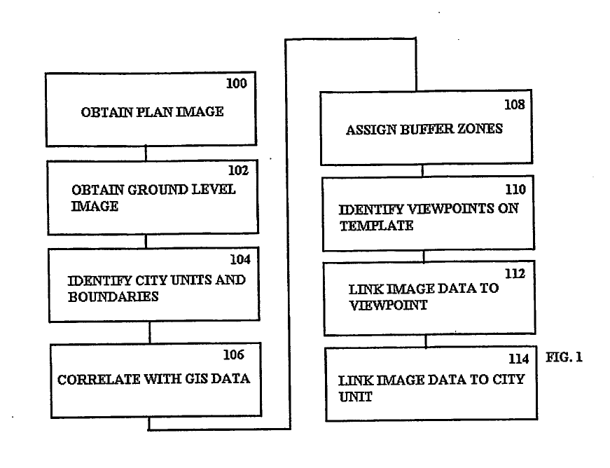

FIG. 1 is a flow diagram showing the steps involved in creating a three dimensional model and database according to the present invention;

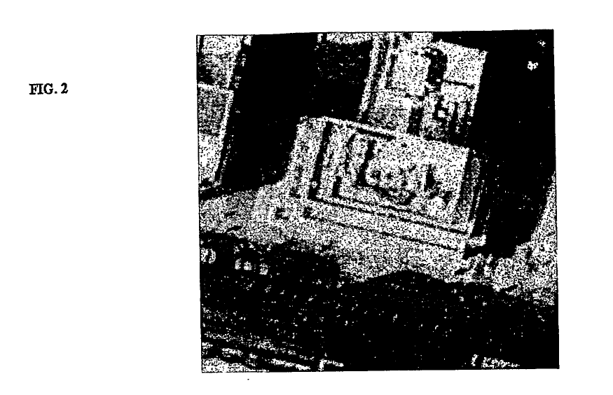

FIG. 2 shows a sample aerial photograph which can be used to create a three dimensional model;

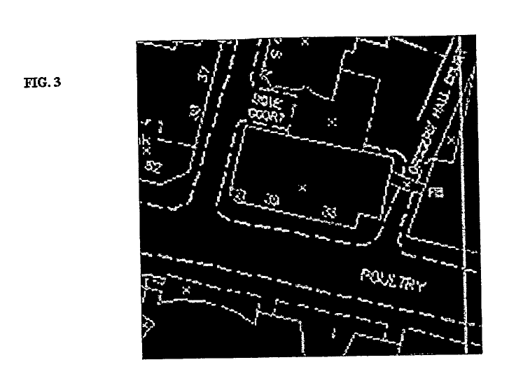

FIG. 3 shows corresponding map data for correlation with the aerial photographs;

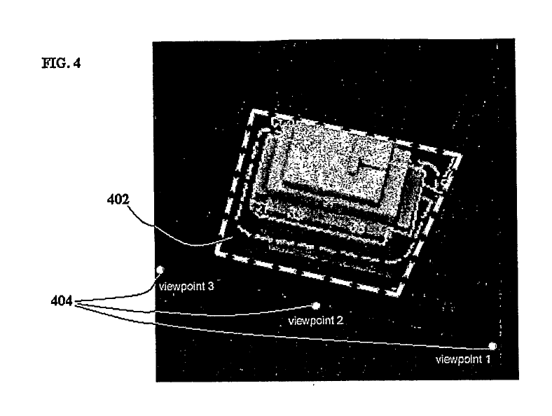

FIG. 4 shows a model template for use according to the present invention;

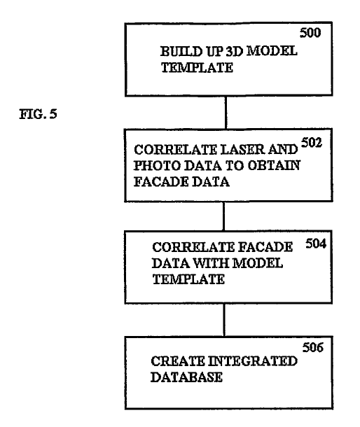

FIG. 5 is a flow diagram showing the steps involved in combining image data according to the invention;

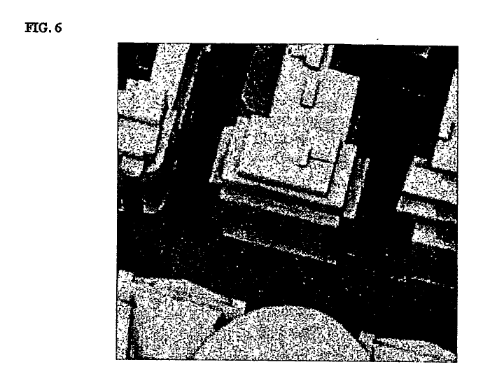

FIG. 6 shows a three dimensional model derived from the aerial photograph;

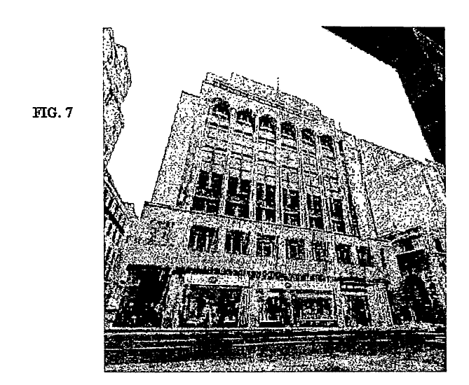

FIG. 7 shows photographic data obtained from a view point;

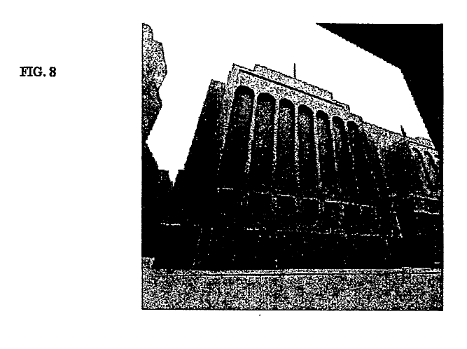

FIG. 8 shows laser cloud data obtained from a view point;

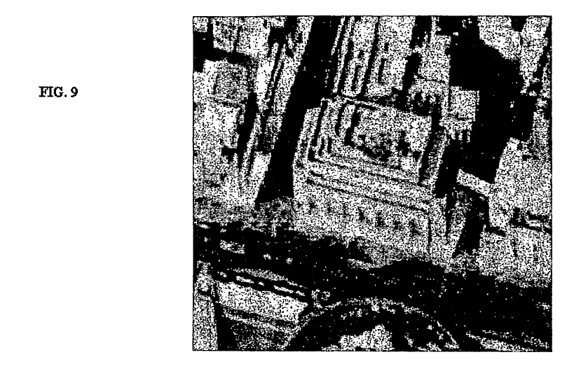

FIG. 9 shows correlated photographic and laser cloud image data;

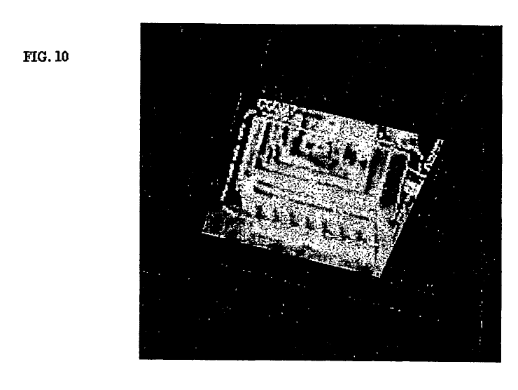

FIG. 10 shows correlated three dimensional model data;

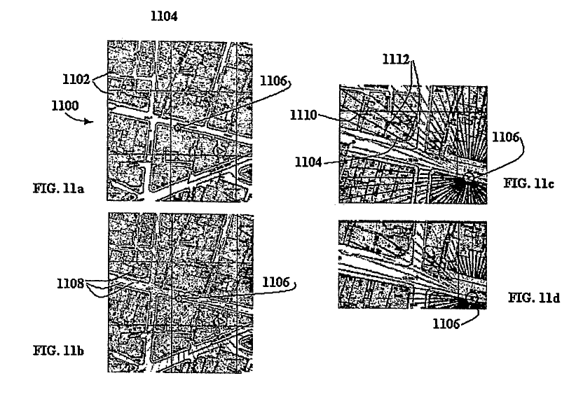

FIGS. 11a to 11d show steps involved in determining which view points a specific building element can be viewed from; and

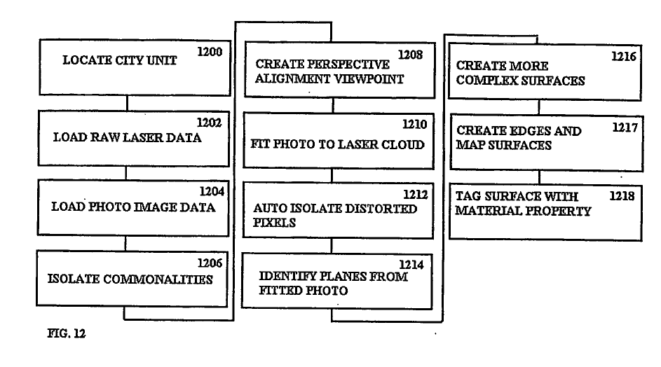

FIG. 12 is a flow diagram showing the steps involved in producing a more detailed visual image according to the method.

In overview, the method described herein uses an aerial photographic plan image as a model template for a built up area such as an urban area. Geographical data is used to identify built up area units such as city units comprising buildings, for example using postal address as identifier. As a result of this the basis for the three dimensional model, forming the model template, is aerial data and geographical data is merely used to identify the respective city units. The city units can include “buffer zones” including additional geographical elements in the environ of the city unit, for example trees or letter boxes. As a result all geographical elements are associated with an identifiable city unit which in turn can be derived from a standard addressing system such as postal address.

The model template is obtained using a stereo aerial image as a result of which a three dimensional model can be derived from the aerial data. The resolution and accuracy of the model is improved further by obtaining ground level or elevated images using for example photographic or laser acquisition techniques. These ground level or elevated images are correlated such that the photographic image can be mapped onto the three dimensional elevational view obtained from the laser data. The images are also correlated with the three dimensional model obtained from the aerial image to provide a full photographic quality and geographically accurate three dimensional model of the built up area. The position of the viewpoints from which the laser or photographic images are acquired are stored and represented on the model template allowing images from the viewpoint to be accessed through a simple link and also allowing simple update of individual city units or parts of the three dimensional model. Conversely each city unit can provide a link to all acquired images which show it again using appropriate links. As a result a fully integrated database is provided underlying the three dimensional model.

Referring now to FIGS. 1 to 4 and 7, the basic steps involved in creating the model template and underlying database can be understood.

At step 100 a plan image of the built up area (FIG. 2) is obtained to provide basis for the model template. This is stereoscopic allowing height data to be derived as well. At step 102, ground or elevated images of the city (FIG. 7) are obtained from defined viewpoints for example by photographic and/or laser acquisition of images. At step 104 city units are identified and their boundaries defined from the aerial image. At step 106 the city units are correlated with the geographical information (FIG. 3) to provide identifiers such as postal addresses for each city unit. At step 108 buffer zones are also assigned to the city unit as part of the city unit, for example adjacent portions of street and any elements such as trees and so forth in that portion to provide the model template correlated image shown in FIG. 4 including city unit 402. At step 110 each of the viewpoints 404 from which ground or elevated images were acquired are identified on the model template and at step 112 the image data related to each viewpoint (bearing in mind that multiple images may have been acquired from each viewpoint) are linked to the viewpoint position on the model template. For example the image of FIG. 7 is associated with viewpoint 2. At step 114 images from which each city unit 402 can be seen are also linked to the respective city unit providing a fully integrated database underlying the model.

The manner in which data from various sources is combined can be understood with reference to the flow chart shown in FIG. 5 with reference also to FIGS. 6 to 10. At step 500 a three dimensional model template is derived from the stereo aerial photography information (FIG. 6). At step 502 the laser cloud (FIG. 8) and photographic data (FIG. 7) obtained from ground level or elevated levels is correlated to obtain facade data (FIG. 9). In particular the photographic data can be mapped onto a three dimensional facade representation obtained from the laser cloud. At step 504 the facade date is correlated with the three dimensional model template and overlaid onto the three dimensional city units (FIG. 10) therein such that, at step 506, the full three dimensional model is provided also including an integrated database of underlying data of either viewpoints and/or city units as discussed above.

It will be appreciated that various appropriate software techniques and products can be adopted to implement the method described above as will be apparent to the skilled reader, but one advantageous approach is described below.

The aerial photographic image is obtained by stereo photography and processed to obtain the three dimensional geometry using, for example, Stereo Analyst available from Erdas (www.erdas.com). In order to coincide with existing tools such as 3D studio available from Discreet (www.discreet.com) the 3D geometry can be created from an inputted triangular stereo aerial photography trace.

In order to obtain city unit boundaries and their identifiers, the three dimensional geometry, aerial photography and underlying map data are overlaid as a result of which the boundaries and postal addresses are obtained. Because the aerial image provides the model template the accuracy of the database is not limited to the accuracy of the geographical data which serves as a cross-check only. The geographical data used can be, for example, obtained from a GIS database. In addition buffer zones are assigned to each city unit as described in more detail above.

To obtain facade images, the laser cloud can be obtained using any appropriate system, for example Cyra Scanners (www.cyra.com). The photographic data is also obtained from one or more viewpoints per city unit. At least three views are preferably obtained, namely left and right of the city unit and central to the unit although even more preferably six views are obtained including elevated views as well to avoid distortion with high buildings. Alternatively or in addition spherical photography can be used to obtain an image of the entire building using, for example, spherical cameras available from Spheron (www.spheron.com). Yet further the photographic images can be taken from adjacent the building and, for example, across the street from the building ensuring that details are not lost because they are obscured by intervening items when taken from across the street. The photographs can be combined and assigned to city units using any appropriate tools such as 3D Studio or Photoshop available from Adobe (www.adobe.com). However the process can be speeded up by layering the three dimensional, photography and map data to identify relevant city units. In particular, one city unit will preferably have many scans and photographs associated with it, automatically organising the data in relation to the city unit means a much faster work flow.

Facade geometry can be obtained from the “laser cloud” of reference points derived from the laser scan. This can be done, for example, by tracing the cloud data by identifying base planes and extrusions and mapping onto corresponding elements on the photography, for example by identifying city units and treating one at a time. Alternatively geometry can be traced from the photograph and the laser cloud overlaid. The system can embrace multiple viewpoints and use mapping tools capable of various software steps. Those software tools and steps include perspective view alignment tools to drape photography from multiple viewpoints onto point data, and tools to align three dimensional points/planes to image pixels. In addition tools include image manipulation tools such as a morph function to create a surface map from two or more sources, colour correction between photographs from different lighting conditions and lens distortion correction. Three dimensional trace tools can be implemented to create faces from cloud data and intuitive cutting and extrusion tools can be used to build detail from simple surfaces. Photography can be automatically mapped to faces produced from the laser cloud data allowing “auto bake” textures. As a result simple “un-wrapped” textures compatible with the directX and openGL graphics standards are provided. The data output is capable of 3D studio/maya/microstation/autocad/vrml support and provides support for digital photography including cylindrical, cubic and sypherical panoramic image data as well as support for laser data from appropriate scanners such as CYRA (ibid), RIEGL (www.giegl.co.at), Zoller & Frohlich (www.zofre.de) and MENSI (www.mensi.com).

Implementation of the techniques in detail will again be supportable by appropriate software and can be understood from the flow diagram of FIG. 12. At step 1200 the respective city unit is identified on the model template and cross-referenced with an index photograph or laser data. At step 1202 raw laser data is loaded; this can be obtained from an auto-reference list against the identified city unit. At step 1204 the photograph images are loaded once again if appropriate from an auto-reference list. If spherical imagery is used then this is auto-rotated to include the entire-city unit. At step 1206 common points or planes on a laser data and photographic are isolated. At step 1208 perspective alignment viewpoints are created as refinement of the mark up position, that is Camera viewpoints recorded on-site have offsets applied to them to correctly align photography to the data. This is to overcome any inaccuracies in the recording of on-site camera positions.

At step 1210 the photography is fitted to the cloud data, for example using known “rubber sheet” techniques, projected from the viewpoint. At step 1212 the most distorted pixels are auto-isolated and these can be replaced with imagery from an alternative photographic viewpoint. For example in this or other cases imagery from different viewpoints can be mixed where it overlaps using for example morph options or alternatively imagery from one viewpoint can be selected over that from other viewpoints. The laser cloud data is thereby coloured with information from the photographic pixels. At step 1214 planes are automatically defined from the fitted photographic image by isolating the coloured laser dots according to user-defined ranges. Some planes, within clearly defined shade and colour thresholds (for example representing surfaces at right angles to each other, one being lit by strong light) can be automatically defined, the edges determined and geometry created. Others can be “fenced” and isolated by the user to describe less obvious surfaces. At step 1216 More complex surfaces, and some details, can be created by taking 2d sections through the cloud data and extruding to form planes. Further detail can be added by hiding planes other than the surface to be modelled and tracing photographic detail or snapping to points within them. At step 1217 edges created within the isolated plane (say windows openings in a wall for example) are automatically read as “cookie cut” surfaces which can be pushed or pulled to produce indentations or extrusions. The resultant surfaces are also automatically mapped with relevant photography. In step 1218 surfaces are tagged with their material properties and function from pre-defined drop down lists such that visual properties are correctly represented. For example windows can be tagged as material “glass” defined accordingly as reflective or transparent. It will be seen that the process is thus significantly accelerated for example the automated process of adding photography to the geometry at step 1217 replaces the lengthy task encountered when using existing tools.

Once the individual units have been fully imaged they are incorporated into the model template against the respective city units providing a full resolution model.

As discussed above the model provides integrated databases by allowing links to data accessible via city units or viewpoints such that the underlying image data can be accessed from either. The database can incorporate laser scan position from the onsite survey including file name, capture time and so forth and similarly the data relating to photographic images taken from ground level or elevated positions can be marked up providing a relational data reference to record the file names of laser data and photo data as well as aerial data for each city unit. This can be carried out as a preliminary step allowing the detailed modelling step described above to be quickly derived from the auto-referenced list carrying details of the photographic, laser and aerial data.

One particular approach allowing the database to contain information identifying which images show which city units can be understood with reference to FIGS. 11a to 11d. Referring firstly to FIG. 11a, a model template 1100 includes a plurality of building elements 1102 defined by boundaries 1104. A viewpoint from which photographic data is acquired is shown at 1106. Referring to FIG. 11b, a plurality of nominal “rays” 1108 is created emanating from the viewpoint 1106. Any angular resolution can be determined governing the number of rays produced and any appropriate radius such as 50 metres can be adopted as the maximum ray range beyond which useful image data is not expected to be acquired. Referring to FIG. 11c each intersection of a given ray 1110 with a boundary 1104 is identified and labelled with the city unit identifier, for example the postal address. Each point of intersection 1112 is numbered sequentially in the radially increasing direction from the viewpoint which is treated as intersection point 1.

Referring to FIG. 11d the extent of each ray extending beyond intersection point 3 is excised, as is that portion of the ray between intersection point 2 and the viewpoint (intersection point 1). The city unit associated with the remaining ray segment is therefore visible from the viewpoint and the label attached to the intersection point, i.e. the city unit address, is recorded against the viewpoint position 1106. Any duplicates are merged and as a result it is possible to record against a viewpoint each city unit which is visible from it. Conversely each city unit may carry a list of all viewpoints from which it can be seen.

The invention can be implemented in any appropriate software or hardware or firmware and the underlying database stored in any appropriate form such as a relational database, HTML and so forth. Individual components can be juxtaposed, interchanged or used independently as appropriate. The method described can be adopted in relation to any geographical entity for example any built up area including urban, suburban, country, agricultural and industrial areas as appropriate.

1. A method of producing a three dimensional model of a built up area comprising obtaining a plan image of a built up area and processing the plan image to provide a model template of the built up area by identifying boundaries defining built up area units.

2. A method as claimed in claim 1 further comprising correlating the model template with a geographical database representing the built up area to assign identifiers from the geographical database to built up area units on the model template.

3. A method as claimed in claim 1 further comprising obtaining image data of the built up area from at least one viewpoint in the built up area.

4. A method as claimed in claim 3 in which the image data is at least one of laser image scan data and photographic image data.

5. A method as claimed in claim 3 in which the image data is correlated with the model template to identify built up area unit boundaries.

6. A method as claimed in claim 3 in which image data showing a built up area unit is linked to the built up area unit on the model template.

7. A method as claimed in claim 3 further comprising identifying the viewpoint on the model template and linking image data acquired from the viewpoint therewith.

8. A method as claimed in claim 7 further comprising tracing at least one nominal ray from a viewpoint and identifying a built up area unit intersected by the ray as visible from the viewpoint.

9. A method as claimed in claim 1 in which the built up area unit comprises an identifiable geographic element.

10. A method as claimed in claim 9 in which the built up area unit is identifiable by a postal address.

11. A method as claimed in claim 10 in which the built up area unit further comprises geographical elements in an environ associated with the postal address.

12. A method as claimed in claim 1 in which the plan image is a photographic plan image.

13. A method of producing a three dimensional model of a built up area comprising obtaining a plan image of the built up area, processing the plan image to provide a model template and correlating the plan image with a geographical database to assign identifiers to geographical elements on the model template.

14. A method of producing a three dimensional model of a built up area comprising providing a model template and processing the model template to identify boundaries defining built up area units, in which the built up area units include an addressable geographical element and geographical elements in the environ thereof.

15. A method of producing a built up area database comprising providing a model template, acquiring image data from at least one viewpoint in the built up area, identifying the viewpoint on the model template and providing a link from the viewpoint on the model template to the associated image data acquired therefrom.

16. A method of producing a three dimensional model of a built up area comprising obtaining photographic image data and laser scan image data of a built up area unit and correlating the photographic image data and laser scan image data to provide a three dimensional facade image for the built up area unit.

17. A method as claimed in claim 16 in which the photographic image data is spherical photographical image data.

18. A computer program comprising a set of instructions configured to implement the method of claim 1.

19. A computer readable medium storing a computer program as claimed in claim 18.

20. A computer configured to operate under the instructions of a computer program as claimed in claim 18.
